(19) United States
(12) Patent Application Publication
(10) Pub. No.: US 2004/0121635 A1
(43) Pub. Date: Jun. 24, 2004

(54) Data plug

(76) Inventor: William Halter III, Tampa, FL (US)

Correspondence Address: US CORPORATIONS, INC., 630 NEPTUNE AVE., ENCINITAS, CA, 92024, US

(21) Appl. No.: 10/732,659

(22) Filed: Dec. 10, 2003

Related U.S. Application Data
(60) Provisional application No. 60/434,771, filed on Dec. 18, 2002.

(51) Int. Cl. H01R 13/44

(52) U.S. Cl. 439/135

(57) ABSTRACT

The current invention is a removable, rubber, self locking data port cover used on MOTOROLA/NEXTEL portable telephones (models CONDOR and EAGLE) for the purpose of protecting the data/charging port from water, liquids and outside elements and adverse environments.

### CROSS-REFERENCE TO RELATED APPLICATION

This application relies on a previously filed provisional application 60434771 filed Dec. 18, 2002.

### STATEMENT REGARDING FEDERALLY SPONSORED RESEARCH OR DEVELOPMENT

Not applicable

### REFERENCE TO SEQUENCE LISTING

Not applicable

### BACKGROUND OF THE INVENTION

1. Field of the Invention

Cellular phones have been around since 1973 and have been susceptible to the elements since day one. Today's cellular/SMR phones are much smaller and are even more susceptible to liquid, dust, and foreign materials, which render them inoperable. I have been in this business for five years now and have seen on a daily basis phone rendered totally inoperable or not functioning properly due to exposure to the elements at the data/charger port which leads to costly replacements. In 2002 I called the manufacture (MOTOROLA) concerning this issue and at that time they informed me that they were not in the business to make data port covers and believed that there was not a problem due to the fact that liquid does not defied gravity. So in late 2002 and early 2003 I designed, developed and manufactured data port covers to prevent the problem.

In July of 2003 I was contracted by MOTOROLA to do installations. At that time I spoke with their representative and showed him the data port covers.

The representative seemed to be interested and asked me to send him samples to Fort Lauderdale, Fla. to show to their engineers. I followed up with the rep on several occasions and finally got the response that they were not interested in the data/charger port covers. On Oct. 20, 2003 Motorola introduced their new line of products which now have a data port/charger cover. I spoke with the rep from MOTOROLA and asked him why they used my design and concept for their own products after they had informed me much earlier that they were not interested in product. After denying the allegations the rep advised me to contact the legal department at Motorola.

### SUMMARY OF THE INVENTION

Briefly described, the present invention comprises a moisture resistant data plug for deterring and protecting the open electronic data port or power supply port on a cellular, PCS, or wireless telephone or mobile communication device and for protecting the inner areas of the phone from adverse environmental conditions. More particularly, the present invention includes a protection device which will allow the user to use or operate his or her communication device in areas or conditions which may cause damage to any and or all electronic areas not designed for general environmental exposures such as water or similar liquids. Further, the present invention includes a shape and design which allows the user to remove and or reinstall the device to their phone without the need for tools of any kind. The device or data plug can be installed or removed by hand.

The manufacturing design of the present invention employs a self latching or locking data plug and system reflecting moisture and liquids and blocking their entry to the phone system.

The function and necessity of the current device is focused on the use of mobile telecommunicating devices. Since the conception of such devices, the conditions by which the phones or communication devices are used vary and adverse at times. The present invention is an improvement of current data port conditions which are open and subject to the outside environments and related conditions. By allowing the data ports to be exposed, as current inventions allow, the phone, its electrical components and related functions are jeopardized.

The current invention alleviates the existing problem of open data ports. The current invention allows for the safe and easy protection of such data ports through a self locking rubber, flexible data port plug.

The data plug invention abilities within the present invention may also be used in combination with most accessories sold for the specific Motorola phones as designated. The data plug does not interrupt, interfere or conflict with any of the standard operating features of the Motorola phone and its accessories.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new data port plug device apparatus and which has many of the advantages of the devices mentioned heretofore and many novel features that result in a data port plug which is not anticipated, rendered obvious, suggested, or even implied by any of the prior art tool guides, either alone or in any combination thereof.

It is another object of the present invention to provide a new data port plug device which may be easily and efficiently manufactured and marketed.

It is a further object of the present invention to provide a new data port plug device which is of a durable and reliable construction.

An even further object of the present invention is to provide a new data port plug device which is susceptible of a low cost of manufacture with regard to both materials and labor, and which accordingly is then susceptible of low prices of sale to the consuming public, thereby making such dimmable light therapy devices economically available to the buying public.

Still yet another object of the present invention is to provide a new data port plug device which provides in the apparatuses and methods of the prior art some of the advantages thereof, while simultaneously overcoming some of the disadvantages normally associated therewith.

Yet another object of the present invention is to provide a new data port plug device which includes a molded latch, molded cover and molded shaft assembly.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION

### Illlustrations

A perspective view of the present invention as viewed herein;

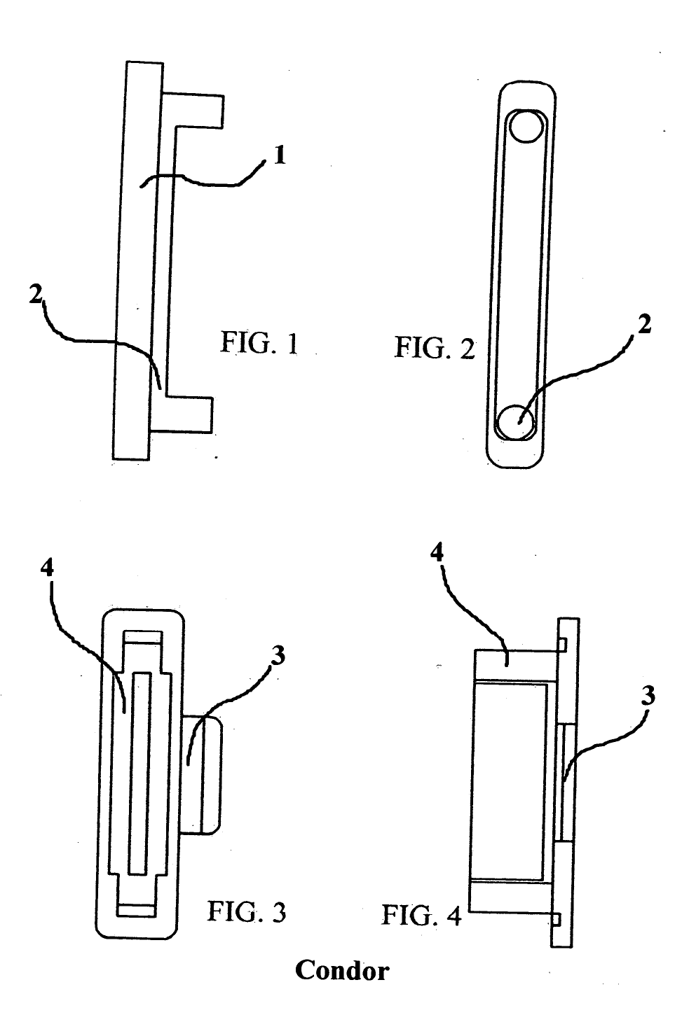

FIG. 1 is a perspective view of the side of the invention developed for the EAGLE model of the MOTOROLA/NEXTEL telephone. FIG. 1, numeral 1 is a perspective view of the outer plug region used to block harsh environmental conditions such as liquid or water. This area of the invention is exposed even after secured to the phone. FIG. 1, numeral 2 depicts the interior locking section of the invention. FIG. 1, numeral 2 depicts the portion of the invention which will be encapsulated by the phone upon insertion of the invention.

FIG. 2 represents the bottom view of the invention. FIG. 2, numeral 2 depicts a view of the portion of the invention which is inserted into the phone for locking and holding purposes.

FIG. 3 is a perspective view of the bottom of the invention developed for the CONDOR model of the MOTOROLA/NEXTEL telephone. FIG. 3, numeral 3 is a perspective view of the removing tab of the invention. FIG. 3, numeral 4 is a perspective view of the internal locking section of the current invention. FIG. 3, numeral 4 is a perspective view of the portion of the invention which is encapsulated by the telephone upon installation.

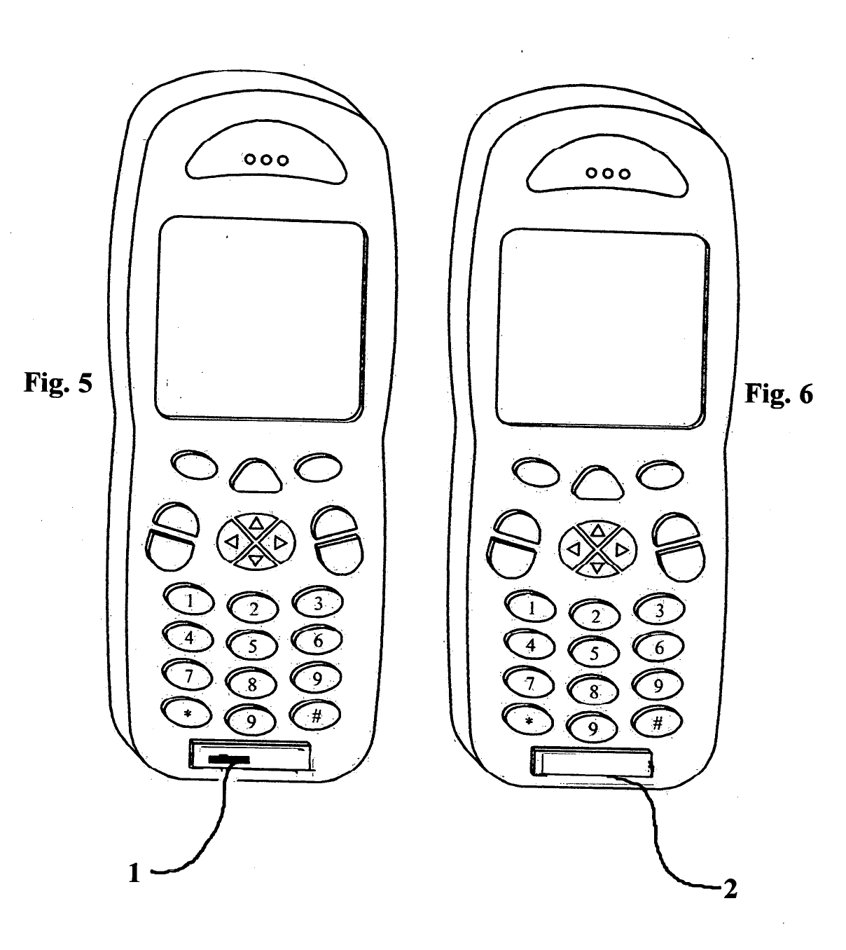

FIG. 5 is a perspective view of the device installed into the MOTOROLA/NEXTEL telephone. FIG. 5, numeral 1 is a perspective view of the invention while installed into the MOTOROLA/NEXTEL telephone.

We claim:

1. A rubber, removable, self locking, portable phone data plug for protecting the electrical, charging and related equipment found within the data port on the bottom of the MOTOROLA/NEXTEL telephones models CONDOR and EAGLE series.

2. A data plug device according to claim 1 wherein the data plug is made from a durable or like rubber based material.

3. A data plug device according to claim 1 wherein the device blocks or deters liquids or water from entering the data port.

4. A data plug device according to claim 1 wherein the device prevents internal phone damage from outside elements.

5. A data plug device according to claim 1 wherein the device is prevents against short or jumping circuits.

6. A data plug device according to claim 1 wherein the device prevents against costly equipment replacement or repairs.
